(19) United States
(12) Patent Application Publication
(10) Pub. No.: US 2026/0118600 A1
(43) Pub. Date: Apr. 30, 2026

(54) TOOL

(71) Applicant: Nippon Telegraph and Telephone Corporation, Tokyo (JP)

(72) Inventors: Norio Sato, Tokyo (JP); Kota Shikama, Tokyo (JP); Yuzo Ishii, Tokyo (JP); Ryo Nagase, Tokyo (JP)

(21) Appl. No.: 18/683,901

(22) PCT Filed: Sep. 28, 2021
(86) PCT No.: PCT/JP2021/035655

§ 371 Date: Feb. 15, 2024

(51) Int. Cl. G02B 6/38

(52) U.S. Cl. CPC G02B 6/3898; G02B 6/3886

(57) ABSTRACT

The tool includes a first operation arm and a second operation arm. The first operation arm and the second operation arm can freely open and close each of tip end portions by an artificial operation. The first operation arm and the second operation arm are crossed at a pivot joint and pivotally provided to each other. Further, the tool includes a first grip portion and a second grip portion in the first operation arm and the second operation arm. In addition, the tool also includes a first chuck fixed to a tip end portion of the first operation arm, and a second chuck fixed to a tip end portion of the second operation arm.

### CROSS-REFERENCE TO RELATED APPLICATIONS

This application is a national phase entry of PCT Application No. PCT/JP2021/035655, filed on Sep. 28, 2021, which application is hereby incorporated herein by reference.

### TECHNICAL FIELD

The present invention relates to a tool used for attaching and detaching optical connectors to and from each other.

### BACKGROUND

In response to an increase in the needs for optical interconnects in a data center, there has been an increase in the need for multi-core optical connectors represented by MT connectors and MPO connectors. In each connector, the MT ferrule end faces are opposed to each other and positioned by pin fitting. Between connection end faces in the single mode fiber connection, an alignment material is applied to the MT connector, and an oblique PC connection to which a pressing force of about 10 to 20 N is applied, is applied to the MPO connector. Although a pressing mechanism using a mechanical element such as a spring or a clip is used for pressing the connection end face and holding the connection state in any connector, there is a limit in miniaturization due to a space limit for holding and attaching and detaching the mechanical element. As a means for solving this problem, an optical connector has been proposed which is miniaturized by eliminating a mechanical element, and in which a magnet is attached to the periphery of a ferrule as a pressing and holding component to develop a magnetic force, as described in NPL 1.

### CITATION LIST

### Non Patent Literature

NPL 1 K. Shikama et al., “Miniature Optical Connector with Magnetic Physical Contact”, Optical Fiber Communication Conference, W2A. 14, 2020.

### SUMMARY

### Technical Problem

However, the configuration using a magnet has a problem in attachment and detachment due to simultaneous occurrence of connection between ferrule connection end faces and connection between magnetic structures. In an optical connector using an attraction force by a magnet, there is a problem that it is difficult to stably connect a receptacle of the optical connector and a plug with high reproducibility because the force attracting them to each other (the magnetic force) suddenly becomes large when a distance between them becomes short. In addition, there is a problem that the operability is low because it is necessary to apply a force greater than the magnetic force in the direction opposite to the attraction force when inserting and removing the magnetic member.

An object of the present invention is to solve the above-described problems, and to improve the operability of connecting an optical connector.

### Solution to Problem

A tool according to the present invention is a tool for removing a magnet provided in a first optical connector from the first optical connector in order to attract and connect the first optical connector and a second optical connector by magnetic attraction force, the tool including a first operation arm and a second operation arm, each of which can be opened and closed at the tip end portion thereof, a first chuck formed of a material attracted to the magnet by the magnetic attraction force and fixed to a tip end portion of the first operation arm, and a second chuck formed of a material attracted to the magnet by magnetic attraction force and fixed to a tip end portion of the second operation arm, in which the magnet is removed from the first optical connector in a state where the first chuck and the second chuck are attracted to the magnet by the magnetic attraction force by operating the first operation arm and the second operation arm to close the tip end portions of the first operation arm and the second operation arm.

### Advantageous Effects of Invention

As described above, according to the present invention, since the first chuck and the second chuck formed of a material attracted to the magnet by magnetic attraction force are provided at the tip end portions of the first operation arm and the second operation arm whose tip end portions can be freely opened and closed, the operability of the connection of the optical connector can be improved.

### BRIEF DESCRIPTION OF THE DRAWINGS

FIG. 1A is a perspective view illustrating a configuration of a tool according to the present embodiment of the present invention.

FIG. 1B is a perspective view illustrating a configuration of a portion of the tool according to the present embodiment.

FIGS. 2(a) to 2(c) are a plan view (a), a side view (b), and a front view (c) illustrating a configuration of a portion of the tool according to the present embodiment.

FIG. 3A is a perspective view illustrating a configuration of a plug 121.

FIG. 3B is a perspective view illustrating a configuration of a portion of the tool according to the present embodiment.

FIG. 4A is a perspective view illustrating a configuration of a tool according to the present embodiment.

FIG. 4B is a perspective view illustrating a configuration of a portion of the tool of the present embodiment.

FIG. 4C is a perspective view illustrating a configuration of the tool according to the present embodiment.

FIG. 4D is a perspective view illustrating a configuration of a portion of the tool according to the present embodiment.

FIG. 5 is an explanatory view for illustrating an insertion and removal operation of the plug 121 and a receptacle 122 using the tool according to the present embodiment.

FIG. 6A is a perspective view illustrating the configurations of the plug 121 and the receptacle 122.

FIG. 6B is a perspective view illustrating a configuration of a portion of the tool according to the present embodiment.

FIG. 6C is a perspective view illustrating a configuration of a portion of the tool according to the present embodiment.

FIG. 6D is a perspective view illustrating a configuration of a portion of the tool according to the present embodiment.

FIG. 7 is an explanatory view illustrating lines of magnetic force (dashed lines) around the plug 121 and the receptacle 122.

FIG. 8 is a configuration diagram illustrating a state where a plurality of pairs of plugs 121 and receptacles 122 are arranged.

FIG. 9A is a plan view illustrating the configurations of the plug 121 and the receptacle 122.

FIG. 9B is a side view illustrating the configurations of the plug 121 and the receptacle 122.

### DETAILED DESCRIPTION OF ILLUSTRATIVE EMBODIMENTS

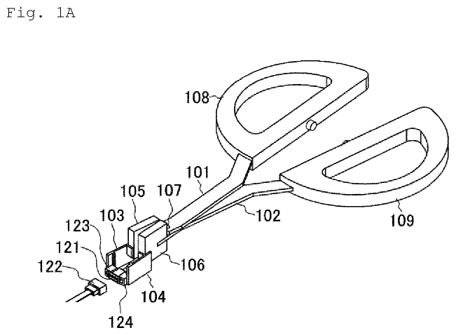

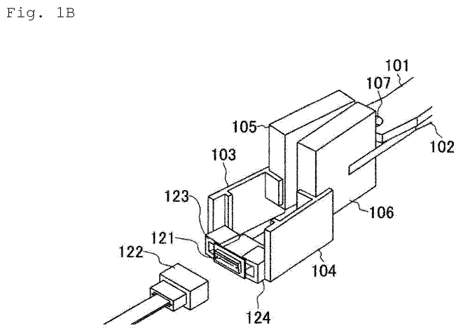

Hereinafter, a tool according to the embodiment of the present invention will be described with reference to FIG. 1A and FIG. 1B. This tool is used for removing a magnet provided on a plug (a first optical connector) 121 from the plug 121 in order to attract and connect the plug 121 and the receptacle (a second optical connector) 122 by magnetic attraction force, and includes a first operation arm 101 and a second operation arm 102. Tip end portions of the first operation arm 101 and the second operation arm 102 can be freely opened and closed with a manual operation. For example, the first operation arm 101 and the second operation arm 102 are cross each other at a pivot joint 107 and are pivotally pivoted with respect to each other. In addition, a tool according to an embodiment includes a first grip portion 108 and a second grip portion 109 in the first operation arm 101 and the second operation arm 102.

The tool includes a first chuck 103 fixed to a tip end portion of the first operation arm 101, and a second chuck 104 fixed to a tip end portion of the second operation arm 102. In this example, the first chuck 103 is fixed to a first movable mechanism 105 at the tip end portion of the first operation arm 101. In addition, the second chuck 104 is fixed to a second movable mechanism 106 at the tip end portion of the second operation arm 102. The first chuck 103 and the second chuck 104 are formed of a material attracted to the magnet by the magnetic attraction force. The first chuck 103 and the second chuck 104 are formed of, for example, a soft magnetic material such as iron having a relative magnetic permeability of about 5000.

The tool is used to remove a first magnet 123 and a second magnet 124 provided on the plug 121 from the plug 121 in order to connect the plug 121 and the receptacle 122 by attracting them by the magnetic attraction force. By operating the first operation arm 101 and the second operation arm 102 using the tool to close each of the tip end portions, in a state where the first chuck 103 and the second chuck 104 are attracted to the first magnet 123 and the second magnet 124 by the magnetic attraction force, the first magnet 123 and the second magnet 124 are removed from the plug 121.

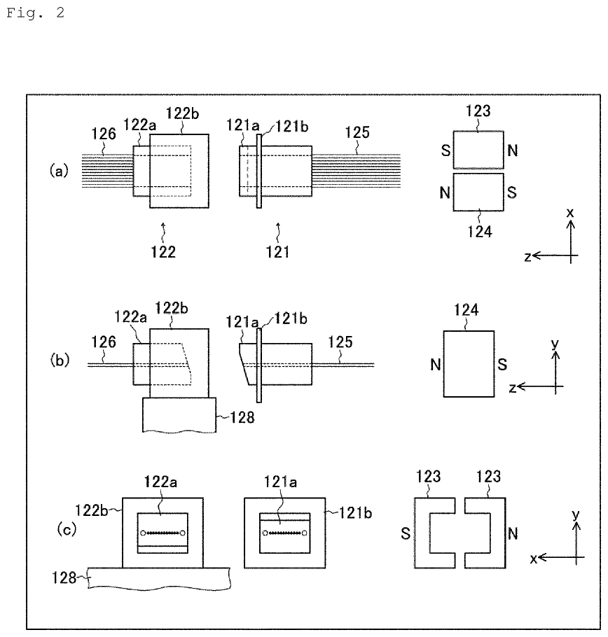

Here, as illustrated in FIG. 2, the plug 121 includes a first ferrule 121a and a frame (first connection component) 121b formed of a soft magnetic material and provided at the connection end of the plug 121. A first optical fiber 125 is connected to the first ferrule 121a.

In addition, the receptacle 122 includes a second ferrule 122a and an adapter (second connection component) 122b formed of a soft magnetic material and provided at the connection end of the receptacle 122. A second optical fiber 126 is connected to the second ferrule 122a. In addition, the receptacle 122 is fixed to a substrate 128.

Each ferrule is, for example, a mechanical transferable (MT) ferrule formed of a resin material and accommodating a multi-core fiber as a connector. In addition, the size of each ferrule is, for example, an end face of about 2.5 mm×6.5 mm with a length of about 8 mm.

The plug 121 and the receptacle 122 are connected by attracting and connecting the frame 121b and the adapter 122b by magnetic attraction force using the first magnet 123 and the second magnet 124.

As described above, the magnet is configured of the first magnet 123 and the second magnet 124. However, the magnet can be configured of a plurality of parts. In this example, the first magnet 123 and the second magnet 124 are integrated when the frame 121b and the adapter 122b are connected, and separated when the frame 121b and the adapter 122b are separated.

The first chuck 103 and the second chuck 104 are formed of a soft magnetic material, and the magnetic permeability of the soft magnetic material configuring the first chuck 103 and the second chuck 104 is higher than that of the soft magnetic material configuring the frame 121b and the adapter 122b. The soft magnetic material may be, for example, SUS430 which is one kind of ferritic stainless alloy steel. The relative permeability of SUS430 is about 1000. With this configuration, even in a state where the first magnet 123 and the second magnet 124 are attracted to the adapter 122b and the frame 121b, by bringing the first chuck 103 and the second chuck 104 close to each other, the first chuck 103 and the second chuck 104 can be sucked with a stronger force.

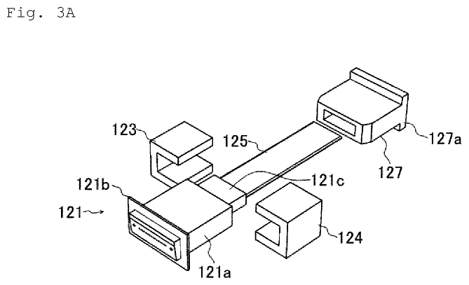

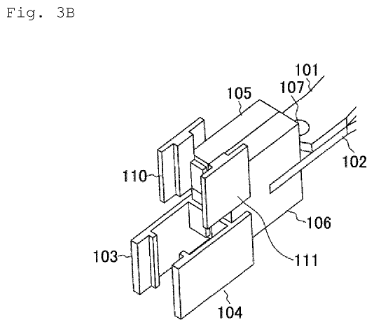

The first magnet 123 and the second magnet 124 can be, for example, a neodymium magnet which is a hard magnetic material, and the residual magnetic flux density is 1,200 MT. The first magnet 123 and the second magnet 124 are configured as a pair, and each has a plane-symmetrical shape (FIG. 2, FIG. 3A). For example, the first magnet 123 and the second magnet 124 can be formed into a “U”-shape in a cross-sectional view. One of the magnetization directions of the first magnet 123 and the second magnet 124 is an N pole and the other is an S pole, and the first magnet 123 and the second magnet 124 are magnetized to attract each other by an attraction force.

As illustrated in FIG. 3A, a boot 121c for mechanically protecting the first optical fiber 125 coming out of the first ferrule 121a can be used. Further, a holder 127 can be used by fitting the holder 127 into the first ferrule 121a. The boot 121c has a role of fixing the holder 127 in addition to a role of mechanically protecting the first optical fiber 125. The holder 127 is fitted into the boot 121c and bonded and fixed, so that the holder 127 and the first ferrule 121a are integrated. The first optical fiber 125 extends through the through hole of the holder 127.

For example, the width of the holder 127 is larger than the width of the first ferrule 122b by about 1 mm. The holder 127 is provided with a stopper 127a whose end is formed into a projecting shape. The first magnet 123 and the second magnet 124 are formed in such a shape as to hold the holder 127 therebetween while attracting each other in a state where the attraction force between them is slightly reduced by a slight distance.

In addition, as illustrated in FIG. 3B, a first push-in chuck 110 and a second push-in chuck 111 can be used. The first push-in chuck 110 is fixed to a tip end portion (the first movable mechanism 105) of the first operation arm 101. The second push-in chuck 111 is fixed to a tip end portion (the second movable mechanism 106) of the second operation arm 102. The first push-in chuck 110 and the second push-in chuck 111 are used for pushing in the direction of the frame 121b from a position separated from the first magnet 123, the second magnet 124 and the frame 121b.

The first push-in chuck 110 and the second push-in chuck 111 can be formed of a soft magnetic material such as nickel. The relative permeability of nickel is about 600. The magnetic permeability of the material configuring the first push-in chuck 110 and the second push-in chuck 111 can be made equal to or less than the magnetic permeability of the soft magnetic material configuring the frame 121b and the adapter 122b.

By this configuration, the first magnet 123 and the second magnet 124 can be attracted by stronger force from the frame 121b when coming into contact with the frame 121b while improving operability in a state where they are attracted when pushing in the first magnet 123 and the second magnet 124. Asa result, the first push-in chuck 110 and the second push-in chuck 111 can be separated from the first magnet 123 and the second magnet 124. Alternatively, a non-magnetic material having a relative magnetic permeability of about 1 such as plastic may be used as the material of the first push-in chuck 110 and the second push-in chuck 111.

By attaching the first chuck 103 and the first push-in chuck 110 to the same first movable mechanism 105 in the vertical direction, and the second chuck 104 and the second push-in chuck 111 to the same second movable mechanism 106 in the vertical direction, two functions of mounting and removing the first magnet 123 and the second magnet 124 can be implemented by one tool.

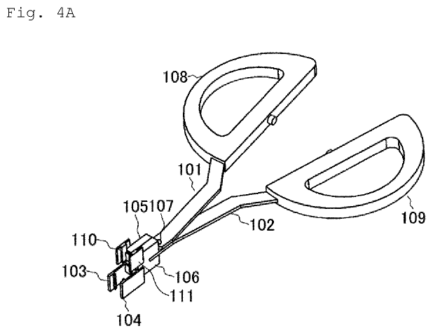

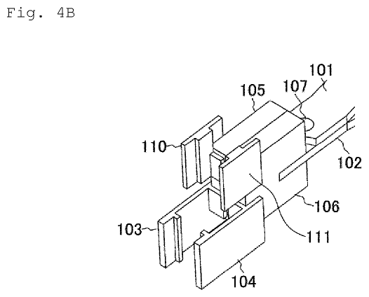

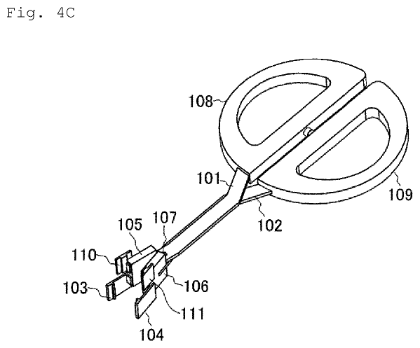

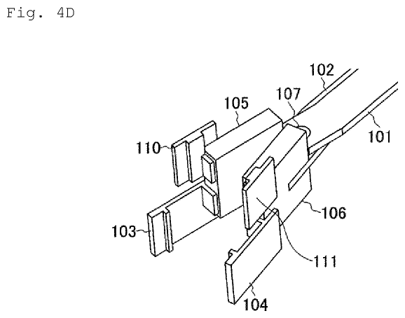

As illustrated in FIGS. 4A and 4B, the tool is in a normally closed state where the first operation arm 101 (the first moveable arm 105) and the second operation arm 102 (the second moveable arm 106) are closed when no external force is applied. It can be realized that the first grip portion 108 and the second grip portion 109 are provided with springs (not illustrated) to open the first grip portion 108 and the second grip portion 109. In this state, the first chuck 103 and the second chuck 104 are in a closed state, and the first push-in chuck 110 and the second push-in chuck 111 are in a closed state.

When a force is applied inward to the first grip portion 108 and the second grip portion 109 to obtain the states illustrated in FIGS. 4C and 4D, a space between the first chuck 103 and the second chuck 104 and between the first push-in chuck 110 and the second push-in chuck 111 can be opened.

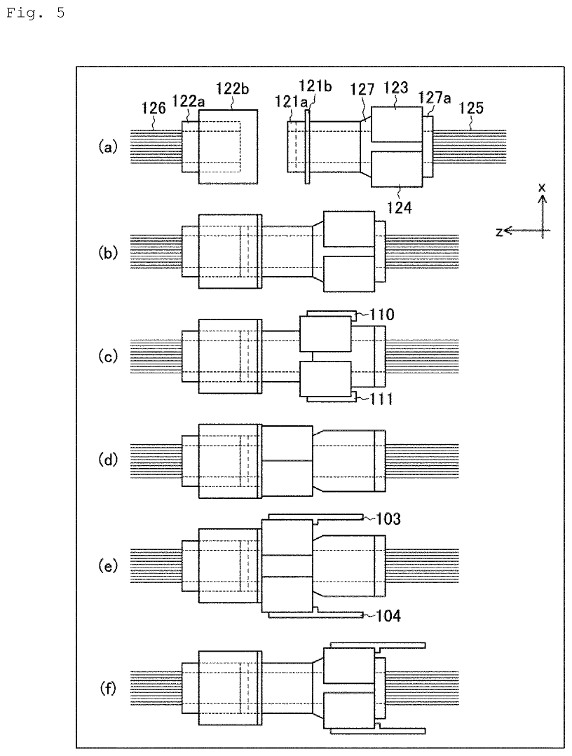

Next, the insertion and extraction operation of the plug 121 and the receptacle 122 using the tool according to the embodiment will be described with reference to FIG. 5. The z-direction illustrated in FIG. 5 is the direction of insertion and extraction. In this example, the x-direction indicates a direction in which the first magnet 123 and the second magnet 124 which are integrated to each other separated from each other.

As illustrated in (a) of FIG. 5, in a state where the plug 121 is spaced apart from the receptacle 122, the first magnet 123 and the second magnet 124 are held to surround the holder 127. Next, as illustrated in (b) of FIG. 4, the plug 121 is manually inserted into the receptacle 122. At this time, since the first magnet 123 and the second magnet 124 are separated from the frame 121b and the adapter 122b, no adverse effect is given to the inserting operation due to the action of magnetic force.

Next, as illustrated in (c) of FIG. 5, the first magnet 123 and the second magnet 124 are moved using the first push-in chuck 110 and the second push-in chuck 111, force in the z-direction is applied to the first magnet 123 and the second magnet 124, and moved from the holder 127 to the first ferrule 121a side, and the first magnet 123 and the second magnet 124 are brought into contact with the frame 121b as illustrated in (d) of FIG. 5. In this state, the first magnet 123 and the second magnet 124 are attracted to the frame 121b and the adapter 122b each other, and the first optical fiber 125 and the second optical fiber 126 are optically connected.

When the plug 121 is pulled out from the receptacle 122, as illustrated in (e) of FIG. 5, the first chuck 103 and the second chuck 104 are attached to the side walls of the first magnet 123 and the second magnet 124. In this state, the first chuck 103 and the second chuck 104 are moved with the first operation arm 101 (the first movable mechanism 105) and the second operation arm 102 (the second movable mechanism 106) to open the first magnet 123 and the second magnet 124 in the x-direction. Since the plug 121 is inserted into the receptacle 122, the first magnet 123 and the second magnet 124 can be removed from the frame 121b.

Since the permeability of the material configuring the first chuck 103 and the second chuck 104 is higher than that of the material configuring the adapter 122b, the attraction force between the first magnet 123 and the second magnet 124 is sufficiently large, and the first chuck 103, the second chuck 104, the first magnet 123, and the second magnet 124 are not separated by this operation. Also, due to the general features of the magnetic force, the attraction force is rapidly lowered as the distance between objects increases.

When moving the first magnet 123 in the x-positive direction and moving the second magnet 124 in the x-negative direction to separate them, at the start of the separation operation, a large external force in the /positive/ negative directions is required. However, since the attraction force between the two abruptly decreases when they are separated by about 1 mm, only a small external force is sufficient for the subsequent separation operation.

Since the tool has a structure provided with the pivot joint 107, the tool strictly draws an arc-shaped locus, however, if a distance between the pivot joint 107 and the first chuck 103 and the second chuck 104 is sufficiently long, since the movement in the z-direction of the first chuck 103 and the second chuck 104 is sufficiently small compared with the movement in the x-direction, the z component of the force applied to the first magnet 123 and the second magnet 124 by the first chuck 103 and the second chuck 104 can be sufficiently small.

In addition, the amount of movement of the first chuck 103 and the second chuck 104 in the x-direction is increased to such an extent that the first magnet 123 and the second magnet 124 are completely removed from the frame 121b, thereby reducing the attraction force and facilitating operation. However, in a case where a plurality of sets of plugs 121 and receptacles 122 are arranged adjacent to each other, there is a limit to the amount of movement in the x-direction. For example, the attraction force can be reduced only by moving the frame 121b by about 2 mm per one side by about a half of the frame 121b.

Thereafter, as illustrated in (f) of FIG. 5, by retracting the first chuck 103 and the second chuck 104 in the z-direction and by hooking the first magnet 123 and the second magnet 124 to the stopper 127a of the holder 127, the first magnet 123 and the second magnet 124 can be removed from the first chuck 103 and the second chuck 104 and be held by the holder 127.

By increasing the width of the holder 127 in the x-direction, the first magnet 123 and the second magnet 124 are prevented from being completely brought into contact with each other, and they are brought into a state where they are attracted by magnetic force by appropriately separating them from each other. Thus, the first magnet 123 and the second magnet 124 are prevented from being scattered or attracted to a magnetic body in a peripheral part, and by confining the magnetic flux generated from the first magnet 123 and the second magnet 124 in a narrow region, the occurrence of magnetic interference to the adjacent magnetic body, metal or the like can be prevented.

In addition, although there is such convenience in use, it is not necessary to hold the first magnet 123 and the second magnet 124 in the holder 127 if there is a space restriction, and it is also possible to form a compact configuration without the holder 127. Thereafter, the plug 121 is pulled out from the receptacle 122 by hand to obtain the state illustrated in (a) FIG. 5.

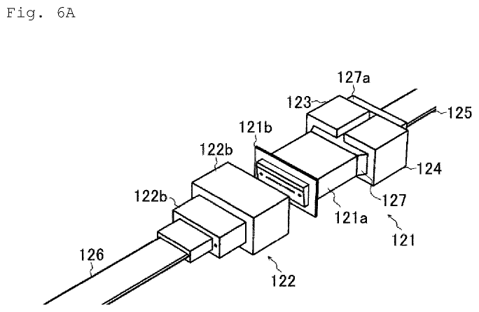

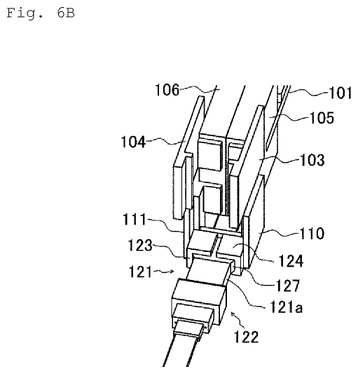

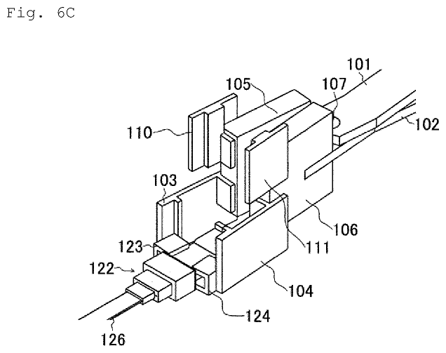

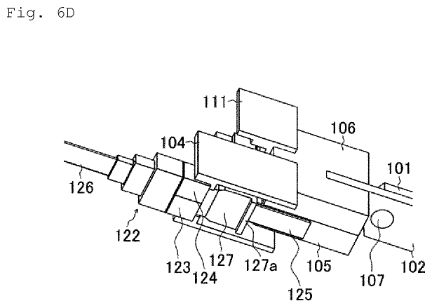

FIG. 6A is a perspective view corresponding to the state illustrated in (a) of FIG. 5. FIG. 6B is a perspective view corresponding to the state illustrated in (c) of FIG. 5, showing how the first magnet 123 and second magnet 124 are pushed in the z-direction by the first push-in chuck 110 and the second push-in chuck 111. Here, since the width of the first ferrule 121a is narrower than the width of the holder 127 in the x direction, the width of the first chuck 103 and the second chuck 104 is narrower than the width of the first push-in chuck 110 and the second push-in chuck 111. When viewed from the y-positive direction, since the operability deteriorates when the contact portions of the first push-in chuck 110, the second push-in chuck 111, and the first magnet 123, the second magnet 124 become difficult to see, visibility is improved by shifting the positions of the first chuck 103 and the second chuck 104 in the z-positive direction, and by increasing the distance between the first chuck 103 and the second chuck 104 above the first push-in chuck 110 and the second push-in chuck 111 (in the y-direction).

FIG. 6C is a perspective view corresponding to the state of (e) of FIG. 5 and illustrates how the first chuck 103 and the second chuck 104 open and remove the first magnet 123, the second magnet 124. Also, the first chuck 103 and the second chuck 104 are positioned in front of the first push-in chuck 110 and the second push-in chuck 111, thereby improving visibility when viewed from above. Although FIG. 6D illustrates a view of the plug 121 and the receptacle 122 from below, the joint structure of the first chuck 103 and the second chuck 104 and the first movable mechanism 105 and the second movable mechanism 106 is such that they do not interfere mechanically with the first optical fiber 125.

In addition, since the first movable mechanism 105, the second movable mechanism 106, the first grip portion 108, and the second grip portion 109 are offset in the y-positive direction, operation can be performed at a position higher than the first optical fiber 125, there is no risk that the first movable mechanism 105 and the second movable mechanism 106 are brought into contact with the first optical fiber 125 at the time of operation and are damaged by pinching or the like.

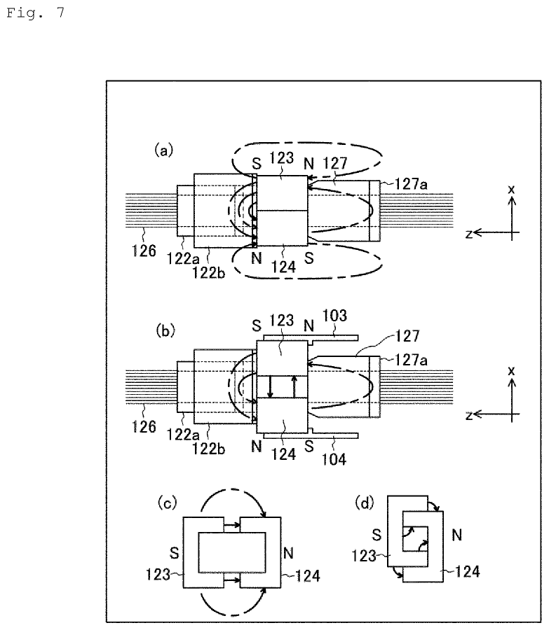

(a) of FIG. 7 illustrates lines of magnetic force (dashed line) corresponding to the state illustrated in (d) of FIG. 4. The structure and magnetization direction of the first magnet 123 and the second magnet 124, and the fact that the frame 121b and the adapter 122b are formed of a soft magnetic material determine the distribution and density of the lines of magnetic force. In this state, the force for moving the first magnet 123 and the second magnet 124 in the z-negative direction against the attraction force of the magnet is as large as about 10 N. On the other hand, the force for moving the first magnet 123 in the x-positive direction and the force for moving the second magnet 124 in the x-negative direction against the attraction force of the magnet is as small as about 1 N.

(b) of FIG. 7 illustrates lines of magnetic force in a state where the first magnet 123 and the second magnet 124 are moved in the opening direction using the first chuck 103 and the second chuck 104 corresponding to the state illustrated in (e) of FIG. 4. When moving the magnet in the x-direction, the magnetic attraction force is originally small, and the first chuck 103 and the second chuck 104 formed of a material with high magnetic permeability are attracted to the first magnet 123 and the second magnet 124. Therefore, the lines of magnetic force converge to pass through the inside of the first chuck 103 and the second chuck 104, and the attractive force between the first chuck 103 and the second chuck 104 and the first magnet 123 and the second magnet 124 increases and the attraction forces with the first magnet 123, the second magnet 124, the frame 121b and the adapter 122b are reduced.

As illustrated in (a) of FIG. 4, (c) of FIG. 7 illustrates a cross-sectional view of a state where the first magnet 123 and the second magnet 124 are held by the holder 127 after the state illustrated in (f) of FIG. 4 with magnetic lines of force. The first magnet 123 and the second magnet 124 are held in stable positions by the holder 127 while being attracted.

(d) of FIG. 7 illustrates a case where there is no holder 127, and illustrates the most stable arrangement of the first magnet 123 and the second magnet 124 from the viewpoint of the attraction force of the magnet. In this state, the line of magnetic force becomes shortest, and since the first magnet 123 and the second magnet 124 attract strong attraction force, a large force and a special tool are required to separate them and mount them on the first ferrule 121a, and operability is extremely deteriorated. The holder 127 has the effect of making the arrangement of the first magnet 123 and the second magnet 124 stable in terms of magnetic force and mechanical stress.

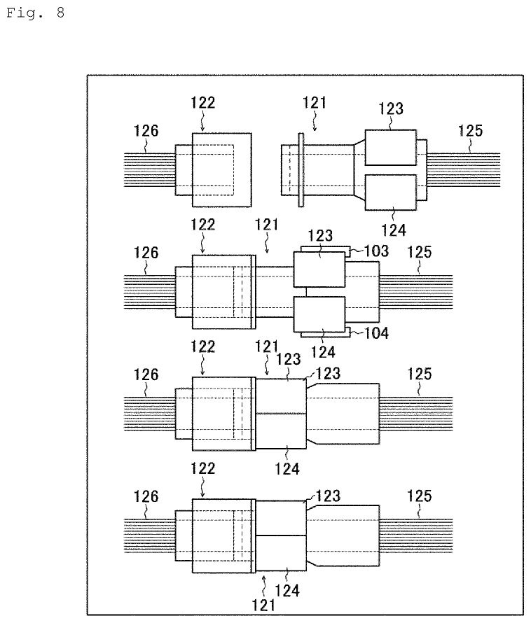

FIG. 8 illustrates a state where a plurality of sets of plugs 121 and receptacles 122 are arranged. In this drawing, a state where the plug 121 is removed from the receptacle 122, a state in which the first magnet 123 and the second magnet 124 are being removed from the first chuck 103 and the second chuck 104, and a state in which the plug 121 is inserted into the receptacle 122 are illustrated. In this way, the tool can be used even in a state where a plurality of sets of the plug 121 and the receptacle 122 are densely arranged in the same space for the same time.

The first chuck 103 and the second chuck 104 have a thin plate structure having high magnetic permeability, so that a plurality of sets of the plug 121 and the receptacle 122 can be arranged with high density. Further, since by giving the tool according to the embodiment the various structural features described above, the visibility and operability are improved even in a narrow space, when inserting and removing the first chuck 103 and the second chuck 104, the first chuck 103 and the second chuck 104 of the adjacent pair are not contacted to affect the optical connection state, and are not damaged by mechanical collision.

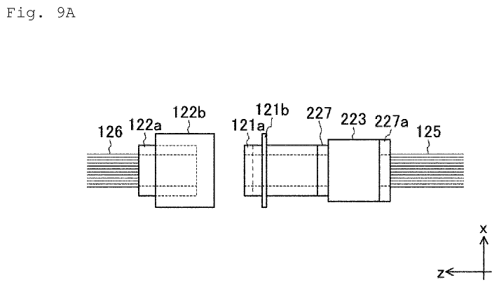

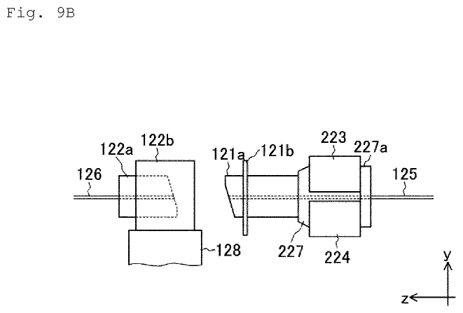

As illustrated in FIGS. 9A and 9B, a first magnet 223 and a second magnet 224 divided in the x-direction may be used, a holder 227 raised in the y-direction be used, and a stopper 227a projected in the x-direction be provided. A plurality of sets of the plug 121 and the receptacle 122 may be determined in consideration of an arrangement direction when arranging the plug 121 and the receptacle 122 and a mechanical space between the plug 121 and the peripheral member.

Although the magnetization directions of the first magnet 123 and the second magnet 124 are two poles, that is, N and S poles, the attraction force can be further increased by making the magnetization of more than two poles. Although the first chuck 103 and the second chuck 104 are formed of a material having high magnetic permeability, electromagnets may be used.

With this arrangement, as illustrated in (a) of FIG. 5 and (d) of FIG. 5, it is possible to separate the procedure of inserting the plug 121 into the receptacle 122 and roughly aligning the tip end portions of the first optical fiber 125 and the second optical fiber 126 with each other, and the procedure of optical connection such as physical contact between the fiber cores by attracting the plug 121 and the receptacle 122 by the first magnet 123 and the second magnet 124 and applying the force to the tip end portions of the first optical fiber 125 and the second optical fiber 126 from the outside.

If the above-described procedure is not separated, positioning and stress are dynamically and instantaneously applied, so that it is not settled in a stable position, and the positioning accuracy is not deteriorated and also the insertion/extraction reproducibility cannot be obtained, and the tip of the fiber and the side surface of the magnet are subjected to an impact force by an instantaneous operation to cause damage and deterioration. By following the procedure of the present embodiment, the alignment accuracy is improved, the optical connection loss is reduced, the breakage and wear of the fiber end face and the magnet are avoided, and the stable optical connection with high repetition reproducibility can be realized.

Further, using the tool including the first chuck 103, the second chuck 104, the first push-in chuck 110, and the second push-in chuck 111 illustrated in (c), (e), and (f) of FIG. 5, the first magnet 123 and the second magnet 124 can be removed and attached (attaching and detecting) in a narrow space. Therefore, a plurality of sets of the plug 121 and the receptacle 122 can be arranged at high density.

If the first magnet 123 and the second magnet 124 are mounted by hand without using a tool, a sufficient space would be required around the set of the plug 121 and the receptacle 122 for a fingertip to enter and in a case of removing the first magnet 123 and the second magnet 124, the suction force is so strong that not only can it not be removed with just the force of the fingertips, but also a large force is required, and if the hand slips, the pair of the adjacent plug 121 and receptacle 122 may be damaged. Using the tool of the present embodiment, a set of the plug 121 and the receptacle 122 can be arranged at a high density, and visibility and operability are improved, so that the optical connectors can be inserted into and removed from each other safely.

As described above, according to the present invention, since the first chuck and the second chuck formed of a material attracting the magnet by magnetic attraction are provided at the tip end portions of the first operation arm and the second operation arm whose tip end portions can be freely opened and closed, the operability of the connection of the optical connector can be improved. According to the present invention, it is possible to provide a tool that realizes stability and reproducibility during insertion and removal, prevention of breakage, deterioration and wear of a fiber tip and a magnet, low-loss optical connection, and high operability.

Meanwhile, the present invention is not limited to the above-described embodiment, and it is apparent that various modifications and combinations can be made by one skilled in the art within a technical idea of the present invention.

### REFERENCE SIGNS LIST

101 First operation arm
102 Second operation arm
103 First chuck
104 Second chuck
105 First movable mechanism
106 Second movable mechanism
107 Pivot joint
108 First grip portion
109 Second grip portion
121 Plug
122 Receptacle
123 First magnet
124 Second magnet.

1-6. (canceled)

7. A tool, comprising:
a first operation arm configured to be opened and closed at a first tip end portion thereof;
a second operation arm configured to be opened and closed at a second tip end portion thereof;
a first chuck formed of a first material attracted to a magnet by magnetic attraction force, the first chuck fixed to the first tip end portion of the first operation arm; and
a second chuck formed of a second material attracted to the magnet by magnetic attraction force, the second chuck fixed to the second tip end portion of the second operation arm, wherein at least part of the magnet is configured to be moved away from a first optical connector in a state where the first chuck and the second chuck are attracted to the magnet, by the magnetic attraction force, in order to attract and connect the first optical connector to a second optical connector by operating the first operation arm and the second operation arm to close the first tip end portion of the first operation arm and the second tip end portion of the second operation arm.

8. The tool according to claim 7, further comprising:
a first connection component formed of a first soft magnetic material and provided at a first connection end of the first optical connector; and
a second connection component formed of the first soft magnetic material and provided at a second connection end of the second optical connector, wherein
the first connection component and the second connection component are attracted and connected by the magnetic attraction force to connect the first optical connector and the second optical connector,
the first chuck and the second chuck are each formed of a second soft magnetic material, and
magnetic permeability of the second soft magnetic material of the first chuck and the second chuck is higher than magnetic permeability of the first soft magnetic material of the first connection component and the second connection component.

9. The tool according to claim 8, further comprising:
a first push-in chuck fixed to the first tip end portion of the first operation arm and configured to push the magnet toward the first connection component from a position away from the first connection component; and
a second push-in chuck fixed to the second tip end portion of the second operation arm and configured to push the magnet toward the first connection component from a position away from the first connection component.

10. The tool according to claim 9, wherein a magnetic permeability of a material of the first push-in chuck and the second push-in chuck is equal to or less than a magnetic permeability of the first soft magnetic material of the first connection component and the second connection component.

11. The tool according to claim 8, wherein:
the magnet comprises a plurality of parts;
the plurality of parts is configured to be integrated in a state where the first connection component and the second connection component are connected; and
the plurality of parts is configured to be separated from each other in a state where the first connection component and the second connection component are separated from each other.

12. The tool according to claim 8, wherein the first operation arm and the second operation arm cross at a pivot joint and are configured to be pivoted with respect to each other.

13. A method, comprising:
connecting, by a tool, first optical connector a second optical connector, wherein the tool comprises a first operation arm, a second operation arm, a first chuck formed of a first material attracted to a magnet by magnetic attraction force, the first chuck fixed to a first tip end portion of the first operation arm, and a second chuck formed of a second material attracted to the magnet by magnetic attraction force, the second chuck fixed to a second tip end portion of the second operation arm, wherein connecting the first optical connector to the second optical connector comprises:
moving, by the magnetic attraction force, at least part of the magnet away from the first optical connector by operating the first operation arm and the second operation arm to close the first tip end portion of the first operation arm and the second tip end portion of the second operation arm.

14. The method according to claim 13, wherein the tool further comprises:
a first connection component formed of a first soft magnetic material and provided at a first connection end of the first optical connector; and
a second connection component formed of the first soft magnetic material and provided at a second connection end of the second optical connector, wherein
the first connection component and the second connection component are attracted and connected by the magnetic attraction force to connect the first optical connector and the second optical connector,
the first chuck and the second chuck are each formed of a second soft magnetic material, and
magnetic permeability of the second soft magnetic material of the first chuck and the second chuck is higher than magnetic permeability of the first soft magnetic material of the first connection component and the second connection component.

15. The method according to claim 14, wherein the tool further comprises:
a first push-in chuck fixed to the first tip end portion of the first operation arm and configured to push the magnet toward the first connection component from a position away from the first connection component; and
a second push-in chuck fixed to the second tip end portion of the second operation arm and configured to push the magnet toward the first connection component from a position away from the first connection component.

16. The method according to claim 15, wherein a magnetic permeability of a material of the first push-in chuck and the second push-in chuck is equal to or less than a magnetic permeability of the first soft magnetic material of the first connection component and the second connection component.

17. The method according to claim 14, wherein:
the magnet comprises a plurality of parts;
the plurality of parts is configured to be integrated in a state where the first connection component and the second connection component are connected; and
the plurality of parts is configured to be separated from each other in a state where the first connection component and the second connection component are separated from each other.

18. The method according to claim 13, wherein the first operation arm and the second operation arm cross at a pivot joint and are configured to be pivoted with respect to each other.
